(19) United States
(12) Patent Application Publication
(10) Pub. No.: US 2005/0089593 A1
(43) Pub. Date: Apr. 28, 2005

(54) Molding apparatus with a pressure sensor for packaging semiconductor device

(75) Inventors: Wei-Chih Wang, Kaohsiung (TW); Kuang-Lin Lo, Kaohsiung (TW); Yun-Lung Chang, Kaohsiung (TW)

Correspondence Address: BACON & THOMAS, PLLC, 625 SLATERS LANE, FOURTH FLOOR, ALEXANDRIA, VA, 22314, US

(73) Assignee: Advanced Semiconductor Engineering, Inc., Kaohsiung (TW)

(21) Appl. No.: 10/876,609

(22) Filed: Jun. 28, 2004

(30) Foreign Application Priority Data
Oct. 24, 2003 (TW) 092129690

(51) Int. Cl. B29C 45/14; B29C 70/72

(52) U.S. Cl. 425/116; 425/117; 425/170

(57) ABSTRACT

A molding apparatus mainly comprises a mold chase holder, a mold chase, a heater and a pressure sensor. The mold chase comprises a mold cavity and a via, wherein the via penetrates the mold-cavity surface of the mold cavity. The mold chase is accommodated by a mold chase holder and there is a heater, for heating the mold chase up, disposed therein. And the pressure sensor for measuring the viscosity of the instant molding flow at the mold-cavity surface of the mold cavity is provided in the via of the mold chase.

### BACKGROUND OF THE INVENTION

1. Field of Invention

This invention relates to a molding apparatus. More particularly, the present invention is related to a molding apparatus having a pressure sensor disposed at the ejection pin located in the mold chase.

2. Related Art

Integrated circuits (chip) packaging technology is becoming a limiting factor for the development in packaged integrated circuits of higher performance. Semiconductor package designers are struggling to keep pace with the increase in pin count, size limitations, low profile, and other evolving requirements for packaging and mounting integrated circuits. Nowadays, ball grid array package (BGA) and chip scale package (CSP) are wildly applied to chip package with high I/Os and assembly package for thermal enhance integrated circuits.

However, as above-mentioned ball grid array package, encapsulation plays an important role. Specifically, there is needed a stable molding or encapsulation flow in encapsulating the integrated circuits device so as to have the liquid encapsulation injected into the mold chase stably and distributed equally in the mold chase. In such a manner, the appearance of said package will be kept in a good condition after the integrated circuits device is encapsulated.

In general, the molding apparatus as shown in FIG. 1 mainly comprises a mold chase holder 110, a mold chase 120 and a heater 130. Therein, the mold chase holder 110 is utilized to accommodate the mold chase 120 and said mold chase 120 has a plurality of mold cavities 121. In addition, the heater 130 is disposed in the mold chase holder 110 to heat the mold chase 120. Because there is no measurement disposed in the mold chase 120 to measure the viscosity of the encapsulation or the attachment of the encapsulation to the mold chase, and there is only a spiral flow tool utilized to measure the viscosity of the instant molding flow or the attachment of the encapsulation to the mold chase, such as the adhesion capability of the instant molding flow to the mold chase 120, after the encapsulation is formed and when the mold chase 120 is removed, there is no idea to be caught to realize the actual viscosity of the instant molding flow at the surface of the mold cavity 121. Thus, the measurement data, such as viscosity of the instant molding flow, measured by the spiral flow tool is usually different from the actual viscosity of the instant molding flow.

Consequently, providing another molding apparatus to solve the mentioned-above disadvantages is the most important task in this invention.

### SUMMARY OF THE INVENTION

In view of the above-mentioned problems, this invention is to provide a molding apparatus having a pressure sensor disposed at the ejection pin in the mold chase to directly measure the pressure applied to the ejection pin by the encapsulation left at the surface of the mold chase so as to get the viscosity of the encapsulation after mold chase is removed. Thus, all related characterization of encapsulation for reference will be caught so as to ensure the quality of the encapsulation utilized in packaging integrated circuits devices.

To achieve the above-mentioned, a molding apparatus is provided, wherein the molding apparatus mainly comprises a mold chase holder, a mold chase, a heater, an ejection pin and a pressure sensor. Therein, the mold chase has a mold cavity and a via, wherein the mold cavity has a mold-cavity surface and the via penetrates the mold-cavity surface; and the ejection pin is disposed in the via for ejecting the formed encapsulation from the mold chase. In addition, the mold chase holder is utilized to accommodate the mold chase, and the heater is disposed in the mold chase holder to heat the mold chase. To be noted, the pressure sensor is disposed at the ejection pin in the mold chase to measure the pressure applied to the ejection pin by the encapsulation left at the mold-cavity surface of the mold cavity.

As mentioned above, the pressure sensor is disposed at the ejection pin in the mold chase so that the viscosity (adhesion capability) of the instant molding flow located at the mold-cavity surface could be gotten. Thus, those who can get the viscosity of the encapsulation, after mold chase is removed, to catch all related characterization of encapsulation to ensure the quality of the encapsulation utilized in packaging integrated circuits devices.

### BRIEF DESCRIPTION OF THE DRAWINGS

The invention will become more fully understood from the detailed description given herein below illustrations only, and thus are not limitative of the present invention, and wherein:

FIG. 1 is a schematic figure illustrating the conventional molding apparatus;

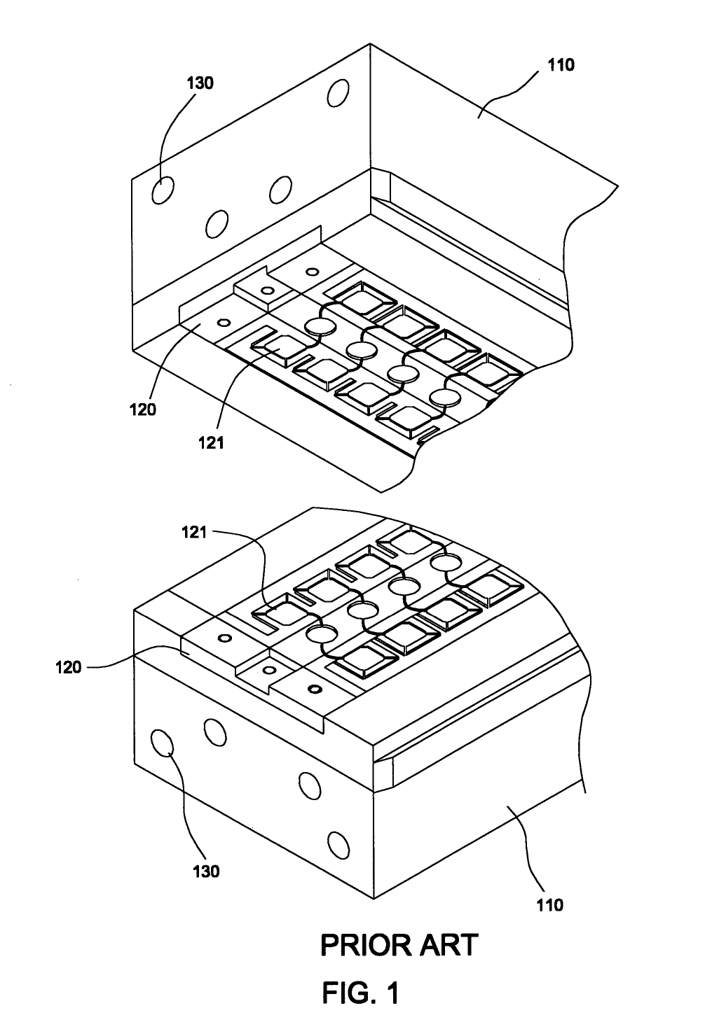

FIG. 2 is a schematic figure illustrating the molding apparatus having a pressure sensor therein according to the preferred embodiment of the present invention; and

FIG. 2A is a schematic figure illustrating the pressure sensor disposed at the ejection pin in the via according to the embodiments of FIG. 2.

### DETAILED DESCRIPTION OF THE INVENTION

The molding apparatus according to the preferred embodiment of this invention will be described herein below with reference to the accompanying drawings, wherein the same reference numbers refer to the same elements.

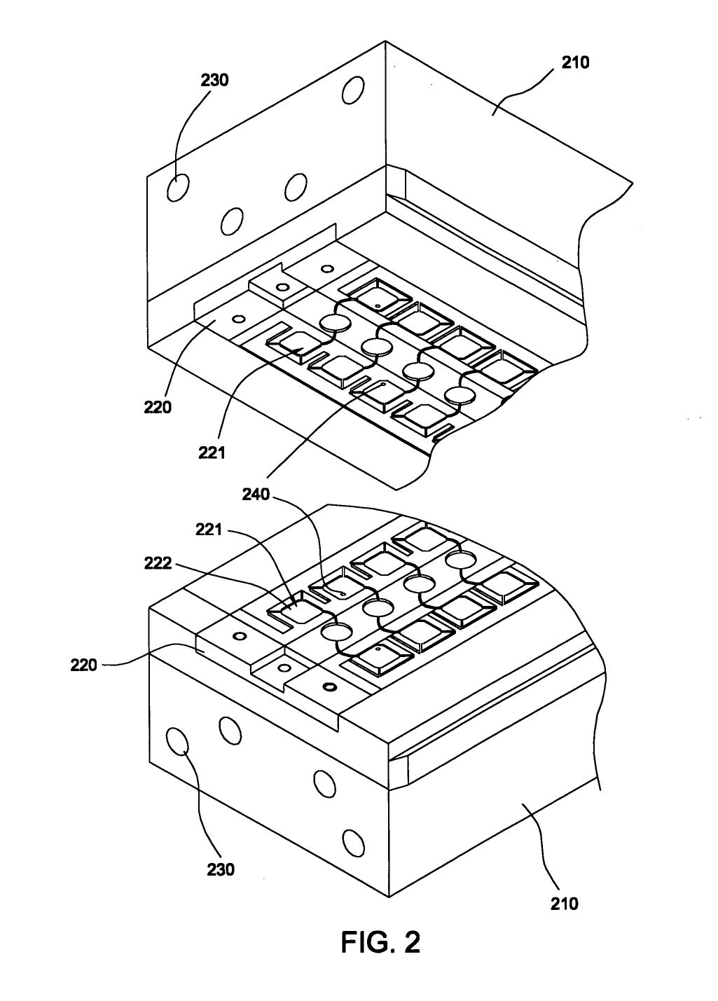

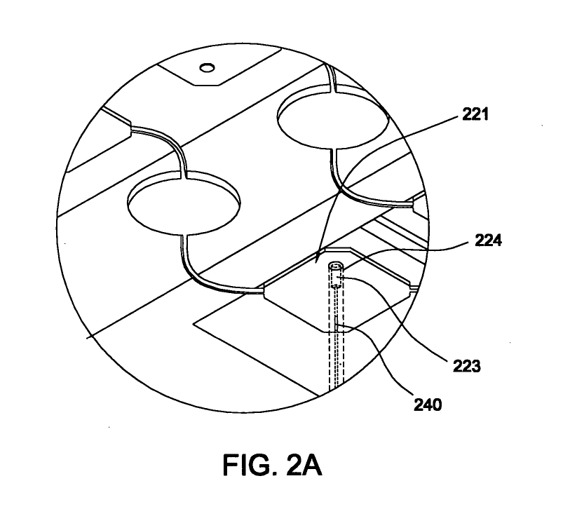

In accordance with a preferred embodiment as shown in FIG. 2, there is provided a molding apparatus. And FIG. 2A illustrates the pressure sensor disposed at the ejection pin located in the via of the mold cavity.

Referring to FIG. 2 again, the molding apparatus mainly comprises a mold chase holder 210, a mold chase 220, a heater 230, and a pressure sensor 240. Therein, the mold chase 220 has a plurality of mold cavities 221, and each mold cavity 221 has a mold-cavity surface 222 and at least one via 224 penetrating the mold-cavity surface 222. Moreover, an ejection pin 223 is disposed in the via 224 and able to be free moved without interference therein for ejecting the formed encapsulation from the mold chase 220. In addition, the mold chase holder 210 is utilized to accommodate the mold chase 220, and the heater 230 is disposed in the mold chase holder 210 to heat the mold chase 220. To be noted, the pressure sensor 240 is disposed at the ejection pin 223 in the via 226 of the mold chase 220 to measure the pressure applied to the ejection pin 228 by the encapsulation left at the mold-cavity surface 222 of the mold cavity 221 to have the compression rod (not shown) deformed. Thus, the viscosity (adhesion capability) of the instant molding flow located at the mold-cavity surface 222 could be gotten through above-mentioned method.

As mentioned above, the pressure sensor 240 is disposed at the ejection pin 223 in the via 226 of the mold chase 220 so that the viscosity (adhesion capability) of the instant molding flow located at the mold-cavity surface 222 could be gotten. Thus, those who can take the actual data as reference to get the viscosity of the encapsulation, after mold chase is removed, to catch all related characterization of encapsulation to ensure the quality of the encapsulation utilized in packaging integrated circuits devices.

Although the invention has been described in considerable detail with reference to certain preferred embodiments, it will be appreciated and understood that various changes and modifications may be made without departing from the spirit and scope of the invention as defined in the appended claims.

1. A molding apparatus, comprising:
a mold chase, the mold chase having a mold cavity wherein the mold cavity has a mold-cavity surface;
a mold chase holder; and
a pressure sensor disposed in the mold chase.

2. The molding apparatus of claim 1, further comprising a heater disposed in the mold chase holder.

3. The molding apparatus of claim 1, further comprising a via penetrating the mold-cavity surface wherein the pressure sensor is disposed in the via.

4. The molding apparatus of claim 1, further comprising an ejection pin disposed in the via wherein the pressure sensor is disposed at the ejection pin.
